(19) United States
(12) Patent Application Publication
(10) Pub. No.: US 2026/0160125 A1
(43) Pub. Date: Jun. 11, 2026

(54) RETRACTABLE BAND MECHANISM FOR CORDLESS CURTAINS

(71) Applicants: BEAUTIFUL WINDOW FASHIONS CO., LTD., CHANGHUA COUNTY (TW); TAICHANG KINGFU PLASTIC MANUFACTURE CO., LTD., TAICANG (CN)

(72) Inventors: SZU-CHANG HUANG, CHANGHUA COUNTY (TW); ZHUO CAI, TAICANG (CN)

(21) Appl. No.: 18/973,996

(22) Filed: Dec. 9, 2024

(51) Int. Cl. E06B 9/322; E06B 9/323; E06B 9/34

(52) U.S. Cl. CPC E06B 9/322; E06B 9/323; E06B 9/34; E06B 2009/3222

(57) ABSTRACT

This invention provides a retractable band mechanism for cordless curtains, comprising two mounting assemblies, two retracting band rollers, multiple clips, and a drive-braking device, the two mounting assemblies each include a mounting seat and a mounting block, the two mounting seats are oppositely positioned at the two ends of the upper beam, while the two mounting blocks are oppositely positioned at the two ends of the lower beam, each mounting block is recessed with a first slot, the retracting band rollers are installed in the mounting seats, each with a winding surface for winding the bands, each winding surface features multiple second slots, the clips are detachably inserted into the first and second slots and are designed with first clip sections to correspond and connect to second clip sections located at the ends of the retracting bands, allowing the ends of the two retracting bands to engage with the clips.

### BACKGROUND OF INVENTION

### 1. Field of the Invention This invention relates to cordless curtains, specifically to a retractable band mechanism for cordless curtains.

### 2. Description of Related Art

The structure of conventional cordless curtains generally consists of a parallel upper beam and lower beam, two retracting bands, multiple ladder bands, and multiple slats connected between the upper and lower beams. Each end of the retracting bands is fixed to a retracting band wheel within a retracting band box. When the retracting band box is installed in the upper beam, the other end of the retracting band is fixed to the lower beam, and vice versa. Similarly, one end of each ladder band is fixed to a ladder band wheel within a ladder band box. When the ladder band box is installed in the upper beam, the other end of the ladder band is fixed to the lower beam, and vice versa. Conventional cordless curtains also include a braking device that connects to the retracting band wheels to control the winding and unwinding of the retracting bands. The braking device uses spring force to support the overall weight of the lower beam, slats, and other components and to hold the lower beam at any desired position.

However, the retracting band box and ladder band box are usually separate in conventional cordless curtain designs, and they are either installed together or separately in the upper or lower beam. When the retracting band box or ladder band box is installed in the lower beam, as disclosed in US2016/0356082, US2016/0356083, and US10138674, the weight of the lower beam increases significantly. This also leads to a substantial difference in gravitational force between the fully retracted and fully extended positions of the slats, increasing the load on the braking device and causing the lower beam to potentially slide downward due to its weight. Using stronger springs or adding damping components to address this issue increases manufacturing costs.

Additionally, in conventional designs, the ends of the retracting bands are fixed to the retracting band wheels by insertion. When the ends of the retracting bands break, repairs are inconvenient.

### SUMMARY OF THE INVENTION

The primary objective of this invention is to provide a retractable band mechanism for cordless curtains that not only provides the driving force for the curtain but also allows the lower beam to be positioned as desired. The connection between the ends of the retracting bands, the retracting band wheels, and the lower beam is stable, and repairs are more convenient in case of damage to the ends of the retracting bands.

To achieve this, the invention provides a retractable band mechanism for cordless curtains, the cordless curtain includes a parallel upper beam and lower beam, multiple slats arranged between the beams, and two retracting bands that pass through the slats to connect the upper and lower beams, the retracting and releasing mechanism is installed in the upper and lower beams and connects the retracting bands to control their winding and unwinding, the mechanism comprises two mounting assemblies, each including a mounting seat and a mounting block, the mounting seats are oppositely positioned at the two ends of the upper beam, and the mounting blocks are oppositely positioned at the two ends of the lower beam, each mounting block is recessed with a first slot, the mechanism also includes two retracting band rollers, which are rotatably installed in the mounting seats, each roller has a winding surface for winding the retracting bands, and each winding surface includes multiple second slots, multiple clips are detachably inserted into the first and second slots and are equipped with first clip sections to connect to second clip sections located at the ends of the retracting bands, enabling the ends of the bands to engage with the clips, additionally, the mechanism includes a drive-braking device installed within the upper beam to control the winding and unwinding of the retracting bands, allowing the lower beam to ascend or descend, the drive-braking device comprises a rotating shaft and an elastic braking unit, the rotating shaft is connected to the retracting band rollers at both ends, and the elastic braking unit generates elastic braking force to control the rotation of the shaft.

### BRIEF DESCRIPTION OF THE DRAWINGS

Hereinafter, two better embodiments of the present invention are cited and described in further detail with the drawings, wherein:

FIG. 1 is a schematic diagram of the preferred embodiment installed in a cordless curtain.

FIG. 2 is a perspective exploded view of the preferred embodiment.

FIG. 3 is a perspective schematic view of the mounting seat, retracting band roller, retracting band, ladder band, rotating shaft, and connecting shaft in the preferred embodiment.

FIG. 4 is a perspective schematic view of the mounting seat, retracting band roller, ladder band wheel, retracting band, ladder band, and drive-braking device in the preferred embodiment.

FIG. 5 is a perspective schematic view of part of the mounting seat, slats, and ladder band in the preferred embodiment.

FIGS. 6 and 7 are the perspective views of the mounting block at different angles in the preferred embodiment.

FIG. 8 is a perspective view of the retracting band roller in the preferred embodiment.

FIG. 9 is a perspective view of the clip and retracting band in the preferred embodiment.

FIG. 10 is a sectional perspective view of the clip and lower beam in the preferred embodiment.

### DETAILED DESCRIPTION OF THE INVENTION

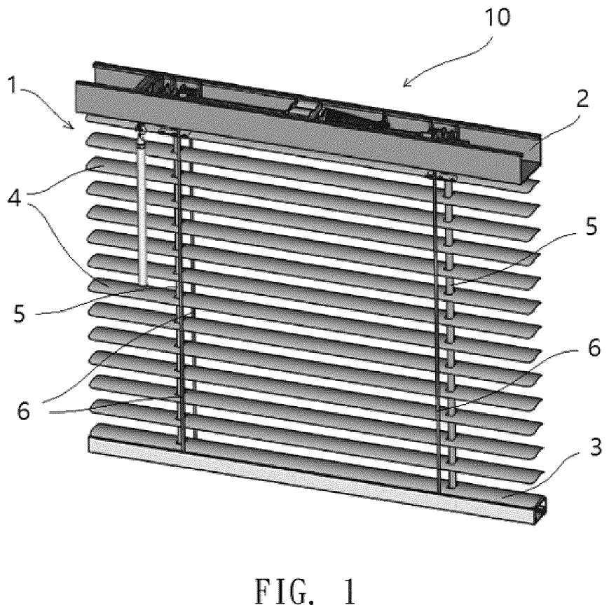

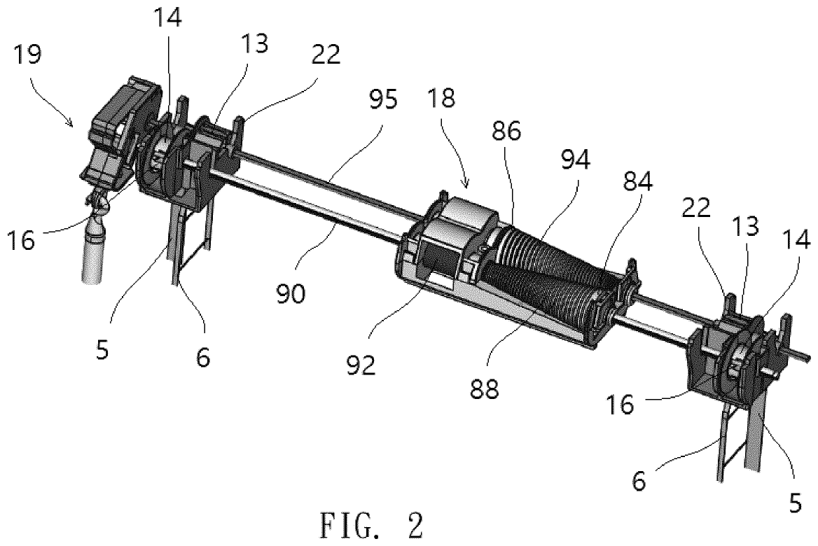

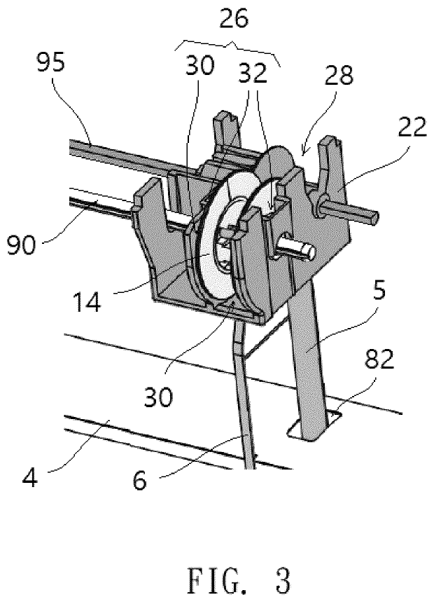

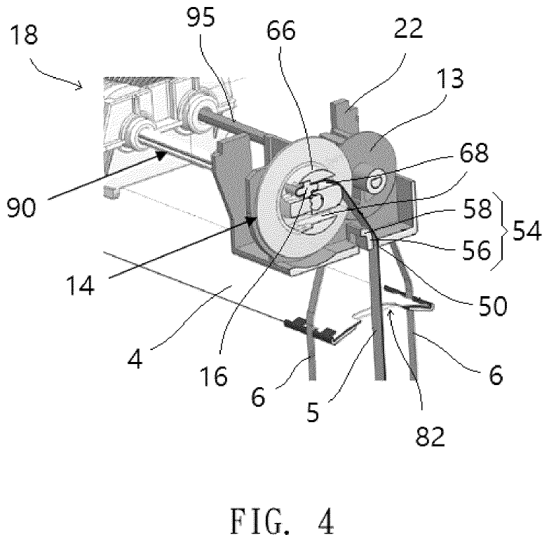

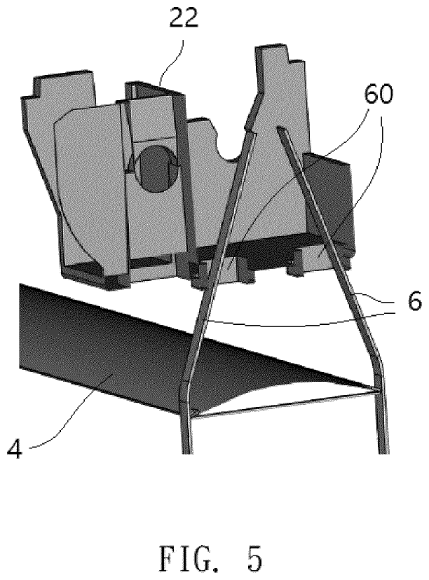

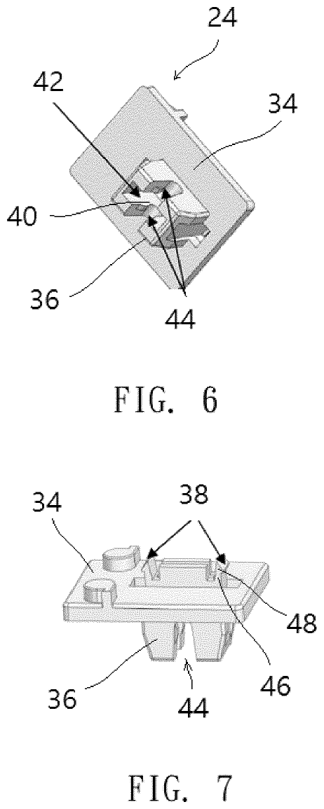

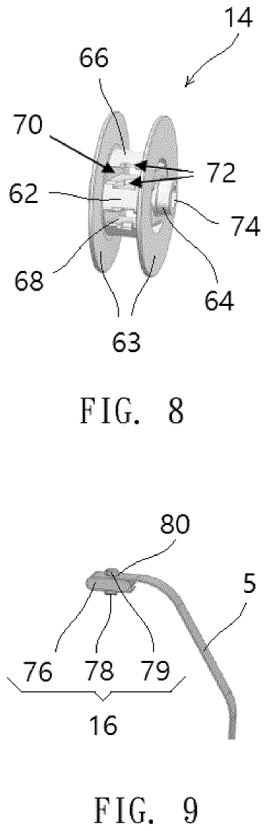

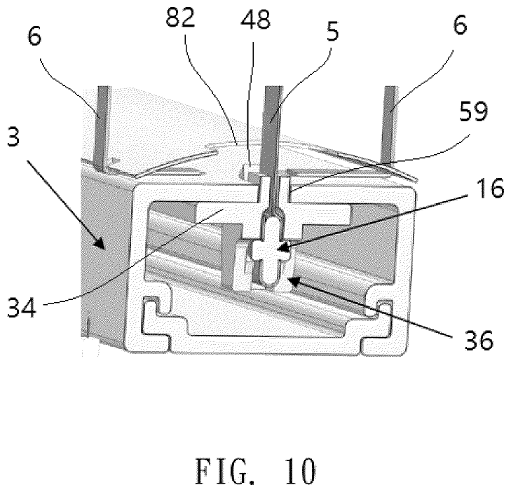

Referring to FIGS. 1 through 10, a retractable band mechanism 10 of the cordless curtain 1 in the preferred embodiment comprises a parallel upper beam 2 and a lower beam 3, both of which are hollow rectangular rods. Multiple slats 4 are arranged between the beams, connected by two retracting bands 5 and multiple ladder bands 6. The retracting and releasing mechanism 10 is installed within the upper beam 2 and lower beam 3, connecting the two retracting bands 5 to control their winding and unwinding, allowing the lower beam 3 to be pulled up or down. The upper beam 2, lower beam 3, slats 4, retracting bands 5, and ladder bands 6 follow conventional cordless curtain designs, which are well known in the art and not detailed here. The unique feature of the invention lies in the retractable band mechanism 10, which includes two mounting assemblies, two retracting band rollers 14, multiple clips 16, and a drive-braking device 18.

The two mounting assemblies each comprise a mounting seat 22 and a mounting block 24. The mounting seats 22 are generally frame-shaped and positioned oppositely at the two ends inside the upper beam 2. Each has two receiving slots 26 and 28. Each receiving slot 26 includes a groove body 30 and two side grooves 32 connected to the groove body 30. Each receiving slot 28 is positioned adjacent to a receiving slot 26. The mounting blocks 24, made of a material such as plastic with suitable elasticity (but not limited to it), include a base plate 34, a socket 36, and two plug blocks 38 on opposite sides of the base plate 34. Each socket 36 features a first slot 40 comprising a first insertion slot 42 and two first engagement slots 44 extending from either side of the insertion slot 42. The insertion slots 42 pass through the base plate 34 to its opposite side. Each plug block 38 includes a rod section 46 and a hook section 48. The rod section 46, capable of elastic deflection, extends from the base plate 34, leveraging the elastic properties of the material. The hook section 48 is located at the end of the rod section 46.

The retracting band rollers 14 are rotatable positioned in the receiving slots 26, with their axis parallel to the ladder band wheels 13. Each roller includes a wheel body 62, two flanges 63, and two axle sleeves 64. The surface of the wheel body 62 forms a winding surface 66, corresponding to the bottom side of the upper beam 2, for winding the retracting band 5. The winding surface 66 has two parallel second slots 68, each comprising a second insertion slot 70 and two second engagement slots 72 extending from either side of the insertion slot 70. Each insertion slot 70 extends through the winding surface 66.

The clips 16 secure the ends of the retracting bands 5 to the retracting band rollers 14 and mounting blocks 24. Each clip 16 includes a plate 76 with two opposing first clip sections 78 and 79 as protrusions. The ends of the retracting bands 5 feature second clip sections 80 as holes spaced at a predetermined distance.

The drive-braking device 18 is installed on the upper beam 2 and serves as a mechanism for controlling the winding and unwinding of the retracting bands 5, enabling the lower beam 3 to ascend or descend. It comprises a first conical drum 84, a second conical drum 86, a connecting cord 88, a rotating shaft 90, and an elastic braking unit 92. The first and second conical drums 84 and 86 rotate in opposite directions, and their surfaces are helically grooved with cord grooves 94. The connecting cord 88 has two ends, which are connected to opposite ends of the first and second conical drums 84 and 86. When the first and second conical drums 84 and 86 rotate in opposite directions, the connecting cord 88 moves and winds around the cord groove 94 of either the first or second conical drum.

The rotating shaft 90 extends parallel to the slats 4 and the upper and lower beams 2 and 3. It passes through the axial center of the first conical drum 84 and connects to the two retracting band rollers 14. When the first conical drum 84 rotates, the rotating shaft 90 synchronously drives the two retracting band rollers 14 to rotate. The elastic braking unit 92, connected to one end of the first and second conical drums 84 and 86, includes an S-shaped spiral spring (not shown in the figures), which provides elastic force for the opposite rotations of the first and second conical drums 84 and 86, thereby controlling the rotational motion of the rotating shaft 90.

The aforementioned components of the drive-braking device 18 are similar to those in conventional drive mechanisms for cordless curtains, and their detailed structures and operations are not elaborated here. The unique feature of the invention lies in that the two ends of the rotating shaft 90 pass through the two mounting seats 22 (receiving slots 26) and the axial holes 74 of the two retracting band rollers 14. Both ends of the rotating shaft 90 are fixedly connected to the two retracting band rollers 14, allowing the retracting band rollers 14 to rotate synchronously when the rotating shaft 90 rotates.

Additionally, the drive-braking device 18 further includes a connecting shaft 95 parallel to the rotating shaft 90. The connecting shaft 95 passes through the second conical drum 86 and connects to the two ladder band wheels 13. The connecting shaft 95 is not fixedly connected to the second conical drum 86, so the connecting shaft 95 does not rotate when the second conical drum 86 rotates. One end of the connecting shaft 95 is connected to a ladder band drive device 19, which is a conventional mechanism in curtains for moving the ladder bands to tilt the slats to a predetermined angle. The detailed structure of the ladder band drive device 19 is not described here. When the ladder band drive device 19 operates, it drives the ladder band wheels 13 to rotate by a predetermined angle in a designated direction through the rotation of the connecting shaft 95.

Thus, in retractable band mechanism 10 of the cordless curtain of the present invention, the ladder band wheels 13, retracting band rollers 14, and drive-braking device 18 are all installed on the upper beam 2. The retracting band rollers 14 are interconnected by the rotating shaft 90 of the drive-braking device 18 and can rotate synchronously. The two ends of the retracting bands 5 are secured to the retracting band rollers 14 and the mounting blocks 24 inside the lower beam 3 using clips 16. When the rotating shaft 90 rotates, the retracting band rollers 14 rotate synchronously, winding or unwinding the retracting bands 5 to raise or lower the lower beam 3 while maintaining consistent height at both ends of the lower beam 3.

When the lower beam 3 is pulled downward, the overlapping slats 4 gradually unfold, and the retracting bands 5 are gradually released from the retracting band rollers 14, thereby driving the retracting band rollers 14 to rotate. The rotating shaft 90 and the first conical drum 84 also rotate synchronously. As the first conical drum 84 rotates, it pulls the second conical drum 86 to rotate via the connecting cord 88, causing the spiral spring inside the elastic braking unit 92 to wind up (the connecting cord 88 gradually winds around the cord groove 94 of the first conical drum 84). When the user releases the lower beam 3, the elastic force of the elastic braking unit 92 acting on the first conical drum 84 and the second conical drum 86, together with the torque generated by the connecting cord 88 pulling on the first and second conical drums 84 and 86, balances the weight of the lower beam 3 and the slats 4. This ensures that the lower beam 3 remains stationary at the desired position without ascending or descending.

Additionally, when the lower beam 3 is pushed upward, the aforementioned force balance is disrupted. The second conical drum 86 rotates under the elastic force of the spring in the elastic braking unit 92, pulling the first conical drum 84 to rotate in the opposite direction via the connecting cord 88 (the connecting cord 88 gradually winds around the cord groove 94 of the second conical drum 86). The rotating shaft 90 also rotates synchronously in the opposite direction, causing the retracting band rollers 14 to wind up the retracting bands 5. Consequently, the slats 4 gradually fold together. In summary, the drive-braking device 18 provides the power for the extension and retraction of the slats 4 and the ascent and descent of the lower beam 3.

Furthermore, the ladder band wheels 13, retracting band rollers 14, and drive-braking device 18 are all installed on the upper beam 2, with the ladder band wheels 13 and retracting band rollers 14 integrated within the mounting seats 22. As a result, the overall weight of the lower beam 3 is reduced. The spring force of the elastic braking unit 92 is sufficient to support the combined weight of the lower beam 3 and the slats 4. When no external force acts on the lower beam 3, the cordless curtain 1 remains in a balanced, stationary state. This addresses the issue in conventional curtains where the placement of retracting band boxes on the lower beam results in significant weight discrepancies between fully retracted and fully extended slats, causing the lower beam to slip due to its weight when stationary.

Moreover, in this invention, the two ends of the retracting bands 5 are detachably secured to the retracting band rollers 14 and the mounting blocks 24 inside the lower beam 3 using clips 16. The two ends of the retracting bands 5 are bent and wrapped around one end of the clip plates 76. Compared to the conventional structure where the ends of retracting bands are fixed to the band rollers using a plug-in method, this invention provides a more secure connection of the retracting band ends to the retracting band rollers 14 and the mounting blocks 24. Even if the ends of the retracting bands 5 break, repair is more convenient. This invention thus offers significant improvements in convenience and reliability.

The above description is merely one preferred embodiment of the present invention and is not intended to limit the scope of the invention. Modifications, variations, and adjustments within the technical knowledge of those skilled in the art are permissible without departing from the spirit and scope of the invention. The scope of protection of this invention shall be defined by the appended claims.

What is claimed is:

1. A retractable band mechanism for cordless curtains, wherein the cordless curtain comprises a parallelly disposed upper beam and lower beam, a plurality of slats arranged in parallel between the upper beam and the lower beam, and two retractable bands extending through the slats to connect the upper beam and the lower beam; the retractable band mechanism is disposed on the upper beam and the lower beam and is connected to the retractable bands for controlling the retraction and release of the two retractable bands, comprising:
two sets of mounting components, each comprising a mounting base and a mounting block, wherein the two mounting bases are oppositely disposed at two ends of the upper beam, the two mounting blocks are oppositely disposed corresponding to the mounting bases at two ends of the lower beam, and each of the mounting blocks is provided with a first slot;
two retractable band rollers, rotatable disposed on the mounting bases, each having a winding surface for winding the retractable band, and each of the winding surfaces is provided with a plurality of second slots;
a plurality of clips, detachably inserted into the first slots and the second slots, each having a plurality of first engaging portions to correspondingly engage with a plurality of second engaging portions at the ends of the retractable bands to secure the ends of the retractable bands to the clips; and
a drive-braking device disposed on the upper beam to control the retraction and release of the two retractable bands such that the lower beam may move upward or downward, the device comprising a shaft and an elastic braking unit connected to the shaft, wherein the shaft extends parallel to the slats and the upper and lower beams, the two ends of the shaft are connected to the two retractable band rollers, and the elastic braking unit generates an elastic braking force to control the rotation of the shaft.

2. The retractable band mechanism for cordless curtains as claimed in claim 1, wherein the two mounting bases are frame-shaped, each comprising a receiving slot to house the retractable band rollers, such that the winding surfaces of the retractable band rollers correspond to the underside of the upper beam, and the two ends of the shaft rotatable extend through the two mounting bases and are secured to the two retractable band rollers.

3. The retractable band mechanism for cordless curtains as claimed in claim 2, wherein each receiving slot comprises a slot body and two side slots connected to the slot body on opposite sides; each retractable band roller comprises a roller body, two axle sleeves protruding from opposite sides of the roller body, and a shaft hole extending through the axle sleeves and the roller body, wherein the roller body is disposed in the slot body, the two axle sleeves are disposed in the side slots, the winding surface is formed around the roller body, and the two ends of the shaft extend through the shaft holes of the retractable band rollers.

4. The retractable band mechanism for cordless curtains as claimed in claim 1, wherein each of the mounting blocks is provided with a base plate and a plurality of interlocking portions disposed on one side of the base plate, the first slot is recessed on the opposite side of the base plate, the lower beam is a hollow rectangular bar, the two ends of the upper side of the lower beam are provided with interlocking holes, and the mounting blocks are fixed to the inner ends of the lower beam by interlocking the interlocking portions with the interlocking holes.

5. The retractable band mechanism for cordless curtains as claimed in claim 4, wherein one side of the base plate of each mounting block is provided with two interlocking portions, each interlocking portion comprising a rod portion and a hook portion, wherein the rod portion is elastically protruding from the base plate into the interlocking hole, and the hook portion is formed at the end of the rod portion and engages with the edge of the interlocking hole of the lower beam.

6. The retractable band mechanism for cordless curtains as claimed in claim 4, wherein each mounting block further comprises a socket, the first slot is formed on the socket and extends through the base plate to one side of the interlocking portion, the clips are inserted into the first slots of the sockets, and the retractable bands extend through the first slots toward the upper side of the lower beam.

7. The retractable band mechanism for cordless curtains as claimed in claim 6, wherein each first slot comprises a first insertion slot and two first engagement grooves connected to the first insertion slot on opposite sides, the first insertion slot extends through the base plate to one side of the interlocking portion, and the first engaging portions of the clips are protrusions inserted into the first engagement grooves.

8. The retractable band mechanism for cordless curtains as claimed in claim 3, wherein the winding surfaces of the two retractable band rollers are each provided with two parallel second slots, and each second slot comprises a second insertion slot and two second engagement grooves connected to the second insertion slot on opposite sides, the second insertion slot extends through the winding surface, and the first engaging portions of the clips are protrusions inserted into the second engagement grooves.

9. The retractable band mechanism for cordless curtains as claimed in claims 7, wherein each clip comprises a plate body with two opposite sides provided with the first engaging portions, and the ends of the retractable bands are each provided with two second engaging portions separated by a predetermined distance, the distance allowing one second engaging portion of the retractable band to be looped around one end of the plate body and engaged with one first engaging portion of the clip, and the other second engaging portion to be looped around the other first engaging portion of the clip.

10. The retractable band mechanism for cordless curtains as claimed in claims 8, wherein each clip comprises a plate body with two opposite sides provided with the first engaging portions, and the ends of the retractable bands are each provided with two second engaging portions separated by a predetermined distance, the distance allowing one second engaging portion of the retractable band to be looped around one end of the plate body and engaged with one first engaging portion of the clip, and the other second engaging portion to be looped around the other first engaging portion of the clip.

11. The retractable band mechanism for cordless curtains as claimed in claim 8, wherein the winding surfaces of the two retractable band rollers are further provided with two protruding edges on opposite sides, and the retractable bands are wound between the two protruding edges on the outer sides of the winding surfaces.

12. The retractable band mechanism for cordless curtains as claimed in claim 2, wherein the two mounting bases are further provided with additional receiving slots to house ladder band wheels, the ladder band wheels are connected to the ends of ladder bands, the opposite ends of the ladder bands are connected to the side edges of the slats and extend toward the lower beam, and the ladder band wheels rotate by a predetermined angle to tilt the slats by a predetermined angle, with the axes of the ladder band wheels parallel to those of the retractable band rollers.

13. The retractable band mechanism for cordless curtains as claimed in claim 2, wherein the two mounting bases and the underside of the upper beam are respectively provided with corresponding first and second through-holes, the second through-holes correspond to through-holes at the center of the slats, the retractable bands extend through the first through-holes, second through-holes, and the slat through-holes, and guiding blocks are provided on one side of the first through-holes at the bottom of the mounting bases to guide the retractable bands.

14. The retractable band mechanism for cordless curtains as claimed in claim 13, wherein each guiding block comprises a plate and a guiding portion, the plate is disposed on one side of the first through-hole, the guiding portion is arc-shaped and formed at the top of the plate with the arc direction facing the retractable band roller, and the retractable bands extend along the guiding portions into the first through-holes.

15. The retractable band mechanism for cordless curtains as claimed in claim 1, wherein the drive-braking device comprises a first cord drum, a second cord drum, and a connecting cord; the shaft extends through the axis of the first cord drum and is connected to the two retractable band rollers, the first cord drum rotates synchronously with the shaft, the surfaces of the first and second cord drums are each provided with spiral cord grooves, the elastic braking unit is connected to opposite ends of the first and second cord drums and provides an elastic force for reverse rotation, and the connecting cord extends between the first and second cord drums and winds around the grooves of the first or second cord drum during reverse rotation.

16. The retractable band mechanism for cordless curtains as claimed in claim 15, wherein the drive-braking device further comprises a connecting shaft parallel to the shaft, the connecting shaft extends through the second cord drum and is connected to the two ladder band wheels, and the connecting shaft does not rotate when the second cord drum rotates.
